(19) United States
(12) Patent Application Publication
(10) Pub. No.: US 2008/0273947 A1
(43) Pub. Date: Nov. 6, 2008

(54) Arrester cable support disc loader

(76) Inventor: Roy K. Baker, Fort Walton Beach, FL (US)

Correspondence Address: Peter Loffler, P.O. Box 1001, Niceville, FL, 32588-1001, US

(21) Appl. No.: 11/799,530

(22) Filed: May 1, 2007

(51) Int. Cl. B65G 57/00

(52) U.S. Cl. 414/27

(57) ABSTRACT

An arrester cable support disc loading system uses a trailer mounted hydraulic piston that has a fork attached thereto. The swedge head of an arrester cable is attached to a support tool that has approximately the same diameter as the swedge head. Discs are loaded onto the handle end of the support tool and are secured to a bracket on the device such that the fork straddles the disc filled support tool. A motor is activated in order to drive a hydraulic cylinder and thus extend the piston. The extending piston slides along an I-beam and over the support tool. While so sliding, the fork presses on each disc and pushes each disc, first onto the tine end of the support tool, then onto the swedge head, and finally onto the arrester cable.

### BACKGROUND OF THE INVENTION

1. Field of the Invention

The present invention relates to a device that loads rubber support discs onto aircraft arrester cables.

2. Background of the Prior Art

All runways that support jet fighter aircraft are typically outfitted with arrester cables. Such arrester cables are stretched taut across the runway and are captured by the tail hook of the aircraft with the arrester cable rapidly yet safely decelerating the aircraft. On limited distance runways and in an emergency situation, such as an aircraft landing with mechanical problems, such arrester cables are what safely stop the aircraft.

In order to ensure that the tail hook of the aircraft ensnares the arrester cable, and is thus decelerated by the cable, the arrester cable must be keep a certain distance above the runway surface, typically on the order of about 2 inches, in order to ensure that the trailing tail hook grabs the cable. To accomplish this elevation of the cable, donut-shaped rubber support discs are spaced evenly over the operational length of the cable. The rubber discs provide the necessary elevation yet, by being made of rubber, do not spark or otherwise threaten the aircraft as the cable is being pulled forward by the ensnared aircraft. As the discs are made of rubber, they become worn through repeated frictional engagement with the runway due to aircraft deceleration and as well from the effects of wind pushing the cable back and forth. Additionally, the rubber tends to get hard and brittle over time. As a result, these rubber support discs have a much shorter life span relative to the metal arrester cable and, as it is imperative that arrester cables maintain a minimum of 2 inches above runway surfaces in order to properly arrest an incoming aircraft, the discs must be frequently replaced.

Although removal of the discs is relatively straightforward, they can simply be cut off of the cable, placement of new support discs onto the cable is more difficult. The ends of the arrester cable are swaged, that is the ends have a swedge head. These swedge heads anchor the arrester cable on either side of the runway. The arrester cable is received and secured within the swedge head and as a result, the swedge head has a larger diameter relative to the diameter of the cable. Each support disc is sized so that its inside diameter—the diameter of its opening—is approximately the same as the outside diameter of the arrester cable so that the support disc, once properly positioned along the length of the arrester cable, remains in position and does not longitudinally move along the cable. A maintainer of the arrester cable can usually move a support disc along the length of the cable without mechanical assistance. However, the end of the cable has a swedge head that has a diameter that is greater than the diameter of the arrester cable and thus greater than the inside diameter of the support disc. As a result, the support disc, which must pass over the swedge head in order to be received upon the arrester cable, must be expanded somewhat in order to fit over the swedge head. Such expansion of the support disc cannot be achieved by the maintainer of the arrester cable alone and he or she must turn to mechanical advantage in order to load each support disc over the swedge head and onto the arrester cable.

The typical method utilized to load support discs over the swedge head and onto the arrester cable involves the use of a pair of vehicles. One vehicle has a support disc loading tool attached to an end thereof such that a cable passes through an opening in the loading tool. One end of this cable is attached to the swedge head of the arrester cable and the other end of this cable is attached to a tow vehicle. The support discs to be loaded over the swedge head and onto the arrester cable are placed onto the cable between the swedge head and the loading tool. The tow vehicle begins moving away from the loading tool which causes the cable to pass through the opening of the loading tool. Eventually, the support discs stack up against the loading tool, being to large to fit through the loading tool's opening, and are eventually pressed by the loading tool over the swedge head as the swedge head passes through the opening of the loading tool. This method works with a certain degree of reliability, however, it requires the use of two personnel and is labor intensive and time consuming.

To simplify and shorten the time period required to fit support discs onto an arrester cable, I have previously invented a system that uses a hydraulic drive to load the support discs over the swedge head and onto the arrester cable. This invention requires only one person to operate and can load support discs onto the arrester cable much faster and safer than the method previously described. My invention is of relatively simple design and construction and is easy to use and maintain.

### SUMMARY OF THE INVENTION

My previous invention works quickly and efficiently, however, through continued research and testing, I have been able to improve on this previous invention by creating a support disc loading tool that is of simpler design so that the device is even less expensive to manufacture and has less potential for breakdown as well as maintaining the overall safety factor. The arrester cable support disc loader of the present invention continues to allow a single operator to be able to quickly and efficiently load multiple support discs over a swedge head and onto an arrester cable in very short order. The present invention is relatively simple to operate, is safe and lightweight, is easily transportable, and requires a workforce of one person.

The arrester cable support disc loader of the present invention is comprised of a frame. A press fork extends upwardly from the frame and has an opening. A hydraulic drive mechanism having a piston is attached to the frame. A support tool with a shaft is attached to the piston. The support tool also has a pair of tines that are attached to the hydraulic piston so that the shaft of the loading tool passes through the opening of the press fork with the tines located on a first of the press fork and the hydraulic piston located on an opposing second side of the press fork. The support disc is impaled by the hydraulic piston shaft and the tines and the first side of the press fork such that when the hydraulic drive is operational, the piston reciprocates between an extended position and a retracted position with respect to the hydraulic drive mechanism and such that when the piston is traveling toward its fully extended position the piston causes the disc impaled on the shaft to abut against the press fork and with continued full outward extension of the piston, the disc is forcibly pressed onto the swedge head and thereafter onto the cable. The frame is located on a trailer. The disc has an outer first diameter and the opening of the press fork has a second diameter that is smaller than the first diameter. A feed rack is attached to the frame. A support plate extends upwardly from the frame with the arrester cable passing through the support plate. The hydraulic drive mechanism is pivotally attached to the frame. The tines of the support tool expand outwardly from the shaft.

### BRIEF DESCRIPTION OF THE DRAWINGS

FIG. 1 is a left side elevation view of the arrester cable support disc loader of the present invention.

FIG. 2 is a right side elevation view of the arrester cable support disc loader.

FIG. 3 is a top plan view of the arrester cable support disc loader.

FIG. 4 is an end view of the arrester cable support disc loader.

FIG. 5 is a perspective view of the arrester cable support disc loader in operation loading support discs onto an arrester cable.

FIG. 6 is a close-up view of the attachment of the swedge head to the spanner fork.

FIG. 7 is a side elevation view of the press fork.

FIG. 8 is a rear elevation view of the press fork.

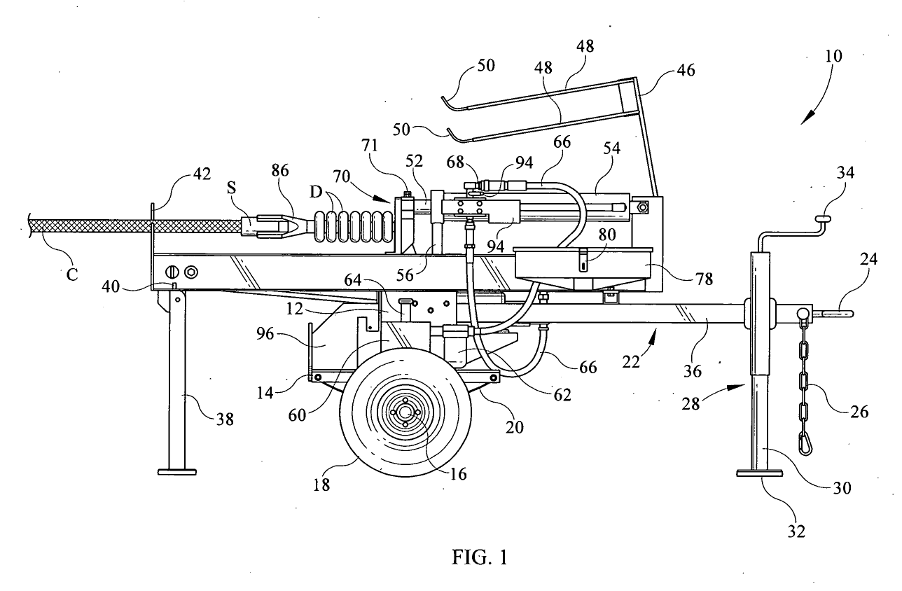

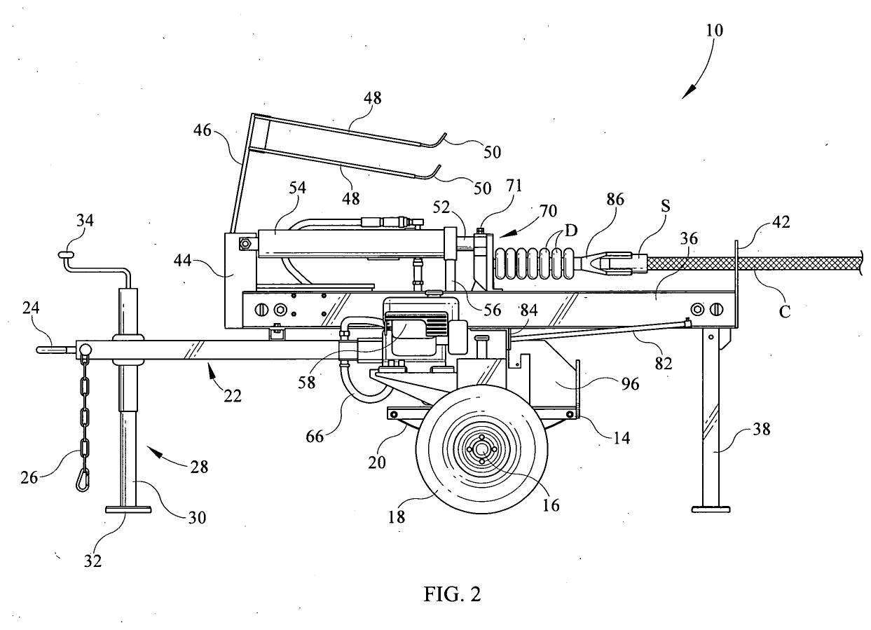

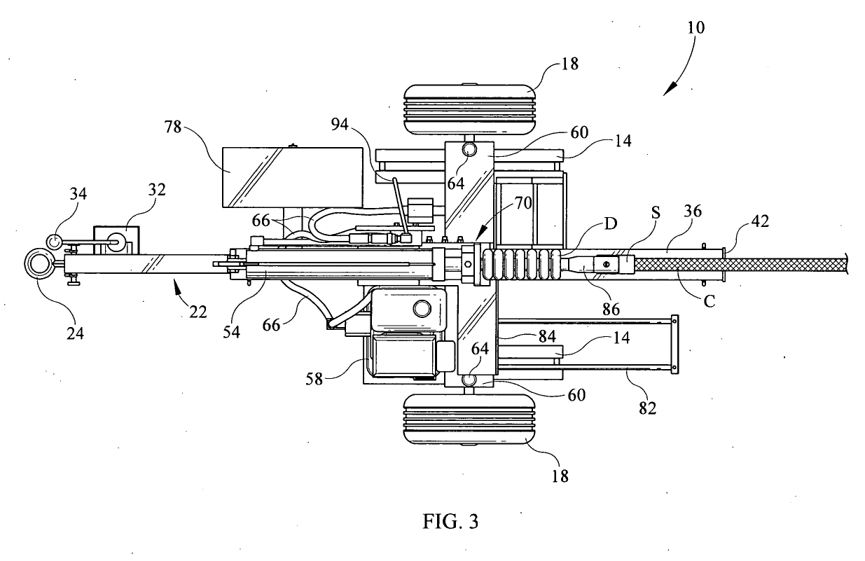

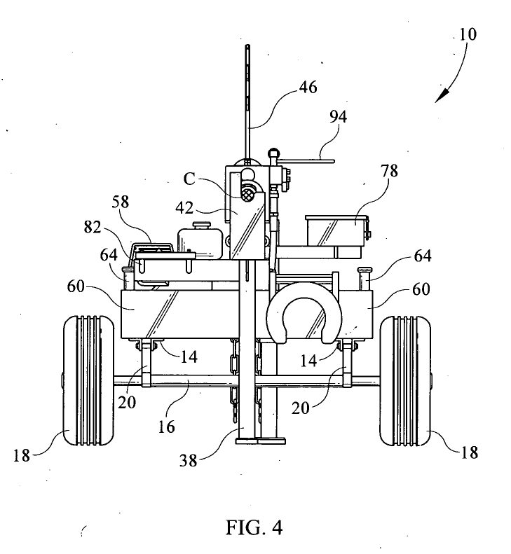

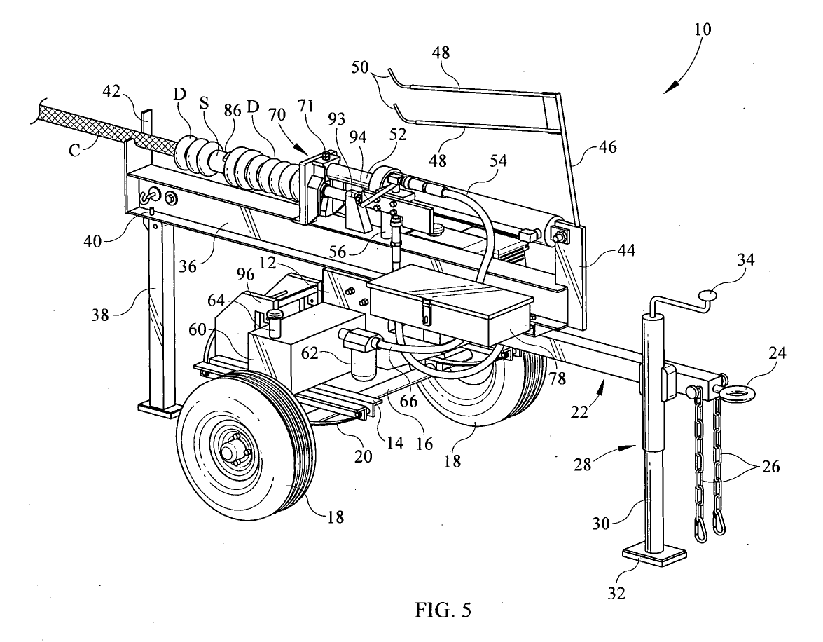

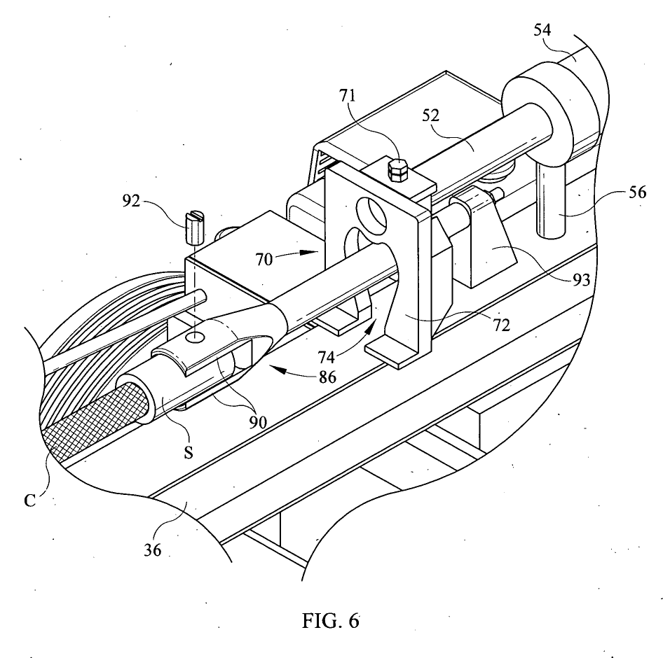

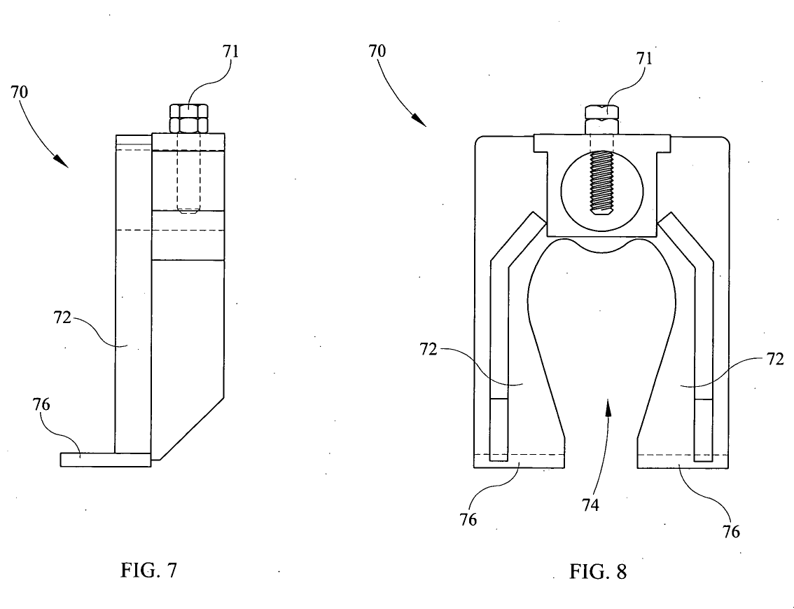

Similar reference numerals refer to similar parts throughout the several views of the drawings.

### DESCRIPTION OF THE PREFERRED EMBODIMENT

Referring now to the drawings, it is seen that the arrester cable support disc loader of the present invention, generally denoted by reference numeral 10, is comprised of a trailer that has a high speed tow package comprising a frame 12 and a support platform 14 attached to the bottom of a hydraulic reservoir 60. An axle 16 is attached to the support platform 14 in appropriate fashion which axle 16 has a pair of pneumatic wheels 18 attached to either end thereof via appropriate wheel hubs (not illustrated). Leaf springs 20 help cushion the device 10 during towing. A tow tongue 22 extends outwardly from the frame 12 and has a pintle hook ring 24 on the end thereof for attachment to a tow vehicle (not illustrated). Safety tow chains 26 are also provided in order to properly secure the trailer to the tow vehicle. A bulldog jack 28 is positioned along the length of the tow tongue 22 and has a retractable leg 30 with a landing pad 32 on a distal end thereon. A crank 34 controls the elevation of the retractable leg 30 such that rotation of the crank 34 causes the leg 30 to lower and counterrotation of the crank 34 causes the leg 30 to rise. Other configurations of the trailer including the tow package and the attachment mechanism for the tow vehicle and the support leg (for example, a third wheel may be used) are possible in keeping within the scope and spirit of the present invention. Additionally, the arrester cable support disc loader 10 may be partially disassembled, leaving the tow package at a home station and the device 10 fitted onto a self-drive device such as a pickup truck or other appropriate vehicle.

A metal I-beam assembly 36 is attached to the tow tongue 22 and to the frame 12 and extends outwardly from the frame 12 in opposite direction relative to the tow tongue 22. A support stand 38, which may but need not be telescoping, is pivotally attached to the I-beam assembly 36 and is capable of pivoting between a stowed position wherein the support stand 38 is generally flush with the I-beam assembly 36 and a support position wherein the support stand 38 is generally normal with respect to the I-beam assembly 36 and wherein a lock pin 40 is provided and passes through the support stand 38 and the I-beam assembly in order to lock the support stand 38 in its support position. A cable support plate 42 extends upwardly from the end of the I-beam assembly 36.

A support bracket 44 extends upwardly from the I-beam assembly 36 at an end opposite the end that has the cable support plate 42. A support disc feed rack 46 extends upwardly from the support bracket 44 and has one or more support tines 48 thereon with the end 50 of each support tine 48 being turned upwardly. A hydraulic cylinder 54 having a piston 52 is pivotally attached to the support bracket 44. A support pylon 56 is attached to the hydraulic cylinder 54 and rests on the I-beam assembly 36, the cylinder 54 being pivoted as needed to assure this resting of the support pylon 56 onto the I-beam assembly.

Drive means are provided for driving the hydraulic cylinder 54 and are of conventional design and include a motor 58, either gasoline (including diesel) or electric, the motor 58 having a hydraulic pump, the hydraulic fluid reservoir 60 having an appropriate filter 62 and fill valve 64, and hydraulic lines 66, each with a quick disconnect fitting 68 extending between the cylinder 54 and the engine 58 and between the cylinder 54 and the reservoir 60.

A press fork 70 is attached to the end of the piston 52 by passing a bolt 71 through the top of the press fork 70 and through an opening (not illustrated) on the hydraulic piston 52. As seen, the press fork 70 has a pair of downwardly directed tines 72 with an open space 74 therebetween and has a pair of feet 76 located on the bottom thereof. The feet 76 just make contact with the top of the I-beam assembly 36.

A tool box 78 with an appropriate latch 80 or other appropriate storage device is attached to the I-beam assembly 36, while an upwardly oriented storage rack 82 is also attached to the I-beam assembly 36 via the illustrated bracket 84.

In order to use the arrester cable support disc loader 10 of the present invention, the trailer is coupled to an appropriate tow vehicle in the usual way. The device 10 is driven to an arrester cable C that needs to have support discs D loaded thereonto. During towing, support discs D may be loaded onto the storage rack 82. When the device 10 is properly in place, with the press fork 70 facing the end of the arrester cable C, the device 10 is decoupled from the tow vehicle (although it does not necessary to be so decoupled) and the retractable leg 30 is lowered via the crank 34 and the support stand 38 is pivoted into its support position and locked thereinto via the lock pin 40. An appropriately sized support tool 86 is retrieved from the tool box 78 or other storage compartment on or off of the device 10, and support discs D are loaded onto the end of the handle end of the support tool 86. The support tool 86 is attached to the swedge head S of the arrester cable C by positioning the swedge head S between the tines 90 of the support tool 86 and passing an appropriate cam locking pin 92 through corresponding openings on the tines 90 of the support tool 86 and the swedge head S. The support tool 86 is attached to the support stanchion 93 so that the support tool 86 passes through the open space 74 of the press fork 70. The arrester cable C rests within the cable support plate 42. The device 10 is now ready for use. An operator controls the device 10 via control valve handle 94, which is an affirmative control valve which means that if the operator releases the handle 94 for any reason, the device 10 immediately ceases operation. Once the control valve handle 94 activates the device, the motor 58 and thus the hydraulic pump become operational. The hydraulic pump charges the cylinder 54 which causes the piston 52 to extend outwardly. The outwardly extending piston 52 causes the press fork 70 to slide along, via its feet 76, the I-beam assembly, the open space 74 of the press fork 70 straddling the support tool 86 and the swedge head S. The sliding press fork 70 eventually makes contact with and presses on the support discs D and presses the discs D onto the tine 90 end of the support tool 86 and eventually onto the swedge head S. The press fork 70 continues sliding until all of the support discs D are pressed past the swedge head S of the arrester cable C. Due to the length of the support tool 86 and the arrester cable swedgehead S, when the hydraulic cylinder 54 fully extends, the hydraulic piston 52 slides the press fork 70 loading rubber support disc D onto the arresting cable C. The hydraulic piston 52 does not fully reach the end of the swedgehead S, leaving two rubber support discs D stationary and located at the end of swedgehead S. A continuous loading of additional rubber support discs D presses the last two discs D onto the arresting cable C. To finalize or to a load single support disc D onto the cable C, a single support disc loading tool 96 is utilized. During the loading cycle, the hydraulic control valve handle 94 is reversed by moving handle 94 toward in opposite direction. When the press fork 70 is fully retracted to the start/load mode, the single support tool 96 is installed by sliding it onto the top of the press fork 70. This procedure adds ten inches of reach of the hydraulic cylinder piston 52, thereby pressing the last remaining rubber support disc D from the swedge head S onto the arresting cable C. At this point, the motor 58 is deactivated, causing the hydraulic cylinder 54 to lose hydraulic pressure thereby causing the piston 52 to retract. The swedge head S is decoupled from the support tool 86 by removing the cam locking pin 92 from the tines 90 and swedge head S. The arrester cable C is reattached to its appropriate attachment point across the runway. The support tool 86 is stowed and the device 10 is moved to its next location.

While the invention has been particularly shown and described with reference to an embodiment thereof, it will be appreciated by those skilled in the art that various changes in form and detail may be made without departing from the spirit and scope of the invention.

I claim:

1. A loading system for loading a support disc onto an arrester cable, the arrester cable having an end with a swedge head, the loading system comprising:
a frame;
a press fork extending upwardly from the frame, the press fork having an opening;
a hydraulic drive mechanism having a piston attached to the frame;
a support tool having a shaft attached to the piston, the support tool also having a pair of tines that are adapted to be attached to the swedge head such that the shaft passes through the opening of the press fork with the tines located on a first side of the press fork and the hydraulic drive located on an opposing second side of the press fork, and such that the support disc is impaled by the shaft and is located between the tines and the first side of the press fork and wherein when the hydraulic drive is operational, the piston reciprocates between an extended position and a retracted position with respect to the hydraulic drive mechanism and such that when the piston is traveling toward its fully extended position, the extension of the piston causes the disc impaled on the shaft to abut against the press fork and with continued extension of the piston, the disc is pressed onto the swedge head and thereafter onto the cable.

2. The loading system as in claim 1 wherein the frame is located on a trailer.

3. The loading system as in claim 1 wherein the disc has an outer first diameter and the opening of the press fork has a second diameter that is smaller than the first diameter.

4. The loading system as in claim 1 further comprising a feed rack attached to the frame.

5. The loading system as in claim 1 further comprising a support plate extending upwardly from the frame, the cable adapted to pass through the support plate.

6. The loading system as in claim 1 wherein the hydraulic drive mechanism is pivotally attached to the frame.

7. The loading system as in claim 1 wherein the tines expand outwardly from the shaft.

8. A loading system in combination with a support disc and an arrester cable having an end with a swedge head, the loading system comprising:
a frame;
a press fork extending upwardly from the frame, the press fork having an opening;
a hydraulic drive mechanism having a piston attached to the frame;
a support tool having a shaft attached to the ram, the support tool also having a pair of tines that are adapted to be attached to the swedge head such that the shaft passes through the opening of the press fork with the tines located on a first side of the press fork and the hydraulic drive located on an opposing second side of the press fork, and such that the support disc is impaled by the shaft and is located between the tines and the first side of the press fork and wherein when the hydraulic drive is operational, the ram reciprocates between an extended position and a retracted position with respect to the hydraulic drive mechanism and such that when the ram is traveling to its fully extended, the extension of the ram causes the disc impaled on the shaft to abut against the press fork and with continued extension of the ram, the disc is pressed onto the swedge head and thereafter onto the cable

9. The loading system as in claim 8 wherein the frame is located on a trailer.

10. The loading system as in claim 8 wherein the disc has an outer first diameter and the opening of the press fork has a second diameter that is smaller than the first diameter.

11. The loading system as in claim 8 further comprising a feed rack attached to the frame.

12. The loading system as in claim 8 further comprising a support plate extending upwardly from the frame, the cable adapted to pass through the support plate.

13. The loading system as in claim 8 wherein the hydraulic drive mechanism is pivotally attached to the frame.

14. The loading system as in claim 8 wherein the tines expand outwardly from the shaft.
